(19) United States
(12) Patent Application Publication
(10) Pub. No.: US 2022/0122351 A1
(43) Pub. Date: Apr. 21, 2022

(54) SEQUENCE RECOGNITION METHOD AND APPARATUS, ELECTRONIC DEVICE, AND STORAGE MEDIUM

(71) Applicant: SENSETIME INTERNATIONAL PTE. LTD., Singapore (SG)

(72) Inventors: Jinghuan CHEN, Singapore (SG); Jiabin MA, Singapore (SG); Chunya LIU, Singapore (SG)

(21) Appl. No.: 17/562,832

(22) Filed: Dec. 27, 2021

Related U.S. Application Data
(63) Continuation of application No. PCT/IB2021/062173, filed on Dec. 22, 2021.

(30) Foreign Application Priority Data
Dec. 20, 2021 (SG) 10202114103T

(51) Int. Cl. G06V 10/82; G06V 10/77; G06V 10/764; G06V 20/64; G06N 3/08

(52) U.S. Cl. CPC G06V 10/82; G06V 10/7715; G06N 3/08; G06V 20/64; G06V 10/764

(57) ABSTRACT

A sequence recognition method is implemented by using a sequence recognition network. The sequence recognition network at least includes an encoder network and a decoder network. The method includes: acquiring a to-be-processed image, the to-be-processed image including a to-be-recognized object sequence; encoding the to-be-processed image by using the encoder network to obtain a first feature sequence; decoding the first feature sequence by using the decoder network to obtain a second feature sequence; and obtaining a sequence recognition result of the object sequence based on the second feature sequence, where the sequence recognition network is obtained by respectively supervising the encoder network and the decoder network.

### CROSS-REFERENCE TO RELATED APPLICATIONS

This application is a continuation of International Application No. PCT/IB2021/062173, filed on Dec. 22, 2021, which claims priority to Singaporean Patent Application No. 10202114103T, filed with IPOS on Dec. 20, 2021. The disclosures of International Application No. PCT/IB2021/062173 and Singaporean Patent Application No. 10202114103T are hereby incorporated by reference in their entireties.

### BACKGROUND

Sequence recognition for images is an important research topic in computer vision. Sequence recognition algorithms have a wide range of applications in scenarios such as scene text recognition and license plate recognition. There are mainly two categories of common algorithms as follows. In the first category of algorithms, firstly, a Convolutional Neural Network (CNN) extracts image features; a Recurrent Neural Network (RNN) is then used to perform sequence modeling on the features; and finally, a Connectionist Temporal Classification (CTC) loss function is used to supervise the prediction of each feature slice and perform de-duplication to obtain an output. In the second category of algorithms, a CNN firstly extracts image features. A visual attention mechanism is then combined to generate attention centers. A corresponding result is finally predicted for each attention center, and other excess information is ignored.

However, existing algorithms have various drawbacks. For example, the main drawbacks of the first category of algorithms include that training in the part of the sequence modeling of the RNN consumes a lot of time and the model can only be separately supervised by the CTC loss function, leading to a limited prediction effect. The main drawback of the second category of algorithms is that the attention mechanism is more demanding in terms of computation and memory usage. Therefore, how to resolve the above problems has become the focus of the research of persons skilled in the art.

### SUMMARY

Embodiments of the disclosure relate to computer vision technologies, and relate to, but not limited to, a sequence recognition method and apparatus, an electronic device, and a storage medium.

In view of the above, embodiments of the disclosure provide a sequence recognition method and apparatus, an electronic device, and a storage medium.

The technical solutions in the embodiments of the disclosure are implemented as follows.

According to a first aspect, embodiments of the disclosure provide a sequence recognition method, implemented by using a sequence recognition network. The sequence recognition network at least includes an encoder network and a decoder network. The method includes: acquiring a to-be-processed image, the to-be-processed image including a to-be-recognized object sequence; encoding the to-be-processed image by using the encoder network to obtain a first feature sequence; decoding the first feature sequence by using the decoder network to obtain a second feature sequence; and obtaining a sequence recognition result of the object sequence based on the second feature sequence, where the sequence recognition network is obtained by respectively supervising the encoder network and the decoder network.

According to a second aspect, embodiments of the disclosure provide a sequence recognition apparatus, implemented by using a sequence recognition network. The sequence recognition network at least includes an encoder network and a decoder network. The apparatus includes a memory storing processor-executable instructions and a processor. The processor is configured to execute the stored processor-executable instructions to perform operations of: acquiring a to-be-processed image, the to-be-processed image comprising a to-be-recognized object sequence; encoding the to-be-processed image by using the encoder network to obtain a first feature sequence; decoding the first feature sequence by using the decoder network to obtain a second feature sequence; and obtaining a sequence recognition result of the object sequence based on the second feature sequence, wherein the sequence recognition network is obtained by respectively supervising the encoder network and the decoder network.

According to a third aspect, embodiments of the disclosure provide a non-transitory computer-readable storage medium having stored thereon computer-executable instructions that, when executed by a processor, cause the processor to perform operations of: acquiring a to-be-processed image, the to-be-processed image comprising a to-be-recognized object sequence; encoding the to-be-processed image by using the encoder network to obtain a first feature sequence; decoding the first feature sequence by using the decoder network to obtain a second feature sequence; and obtaining a sequence recognition result of the object sequence based on the second feature sequence, wherein the sequence recognition network is obtained by respectively supervising the encoder network and the decoder network.

### BRIEF DESCRIPTION OF THE DRAWINGS

FIG. 1 is a first schematic flowchart of implementation of a sequence recognition method according to an embodiment of the disclosure;

FIG. 2 is a second schematic flowchart of implementation of a sequence recognition method according to an embodiment of the disclosure;

FIG. 3 is a third schematic flowchart of implementation of a sequence recognition method according to an embodiment of the disclosure;

FIG. 4 is a fourth schematic flowchart of implementation of a sequence recognition method according to an embodiment of the disclosure;

FIG. 5 is a fifth schematic flowchart of implementation of a sequence recognition method according to an embodiment of the disclosure;

FIG. 6A is a schematic diagram of an image including a game token sequence according to an embodiment of the disclosure;

FIG. 6B is a schematic structural diagram of a deep learning neural network according to an embodiment of the disclosure;

FIG. 7 is a schematic structural diagram of a sequence recognition apparatus according to an embodiment of the disclosure; and

FIG. 8 is a schematic diagram of a hardware entity of an electronic device according to an embodiment of the disclosure.

### DETAILED DESCRIPTION

The technical solutions of the disclosure are further described below in detail with reference to the accompanying drawings and the embodiments. Apparently, the described embodiments are merely some rather than all of the embodiments of the disclosure. All other embodiments obtained by persons of ordinary skill in the art based on the embodiments of the disclosure without creative efforts shall fall within the protection scope of the disclosure.

In the following description, reference is made to “some embodiments”, which describes a subset of all possible embodiments, but it may be understood that “some embodiments” may be the same subset or a different subset of all possible embodiments, and may be combined with each other without conflict.

In the description that follows, suffixes such as “module”, “portion” or “unit” are used to denote components only to facilitate the description of the disclosure and have no specific meanings of their own. Therefore, “module”, “portion” or “unit” may be used interchangeably.

It needs to noted that references to the terms “first, second, and third” in the embodiments of the disclosure are only to distinguish similar objects and do not denote a specific order of objects, but rather the terms “first, second, and third” are used to interchange specific orders or sequences, where appropriate, to enable embodiments of the disclosure described herein to be practiced in an order other than the order shown or described herein.

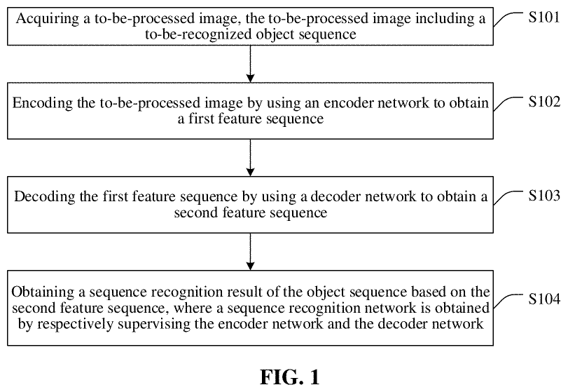

Embodiments of the disclosure provide a sequence recognition method. The method is applied to an electronic device. The functions implemented by the method can be implemented by calling program code through a processor in the electronic device. Certainly, the program code may be stored in a storage medium of the electronic device. FIG. 1 is a first schematic flowchart of implementation of a sequence recognition method according to an embodiment of the disclosure. The method is implemented by using a sequence recognition network. The sequence recognition network at least includes an encoder network and a decoder network. As shown in FIG. 1, the method includes the following steps.

In step S101, a to-be-processed image is acquired, the to-be-processed image including a to-be-recognized object sequence.

The electronic device may be a smartphone, a tablet computer, a notebook computer, a palmtop computer, a desktop computer, a Personal Digital Assistant (PDA) or the like with an information processing capability.

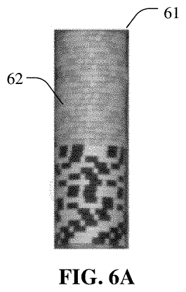

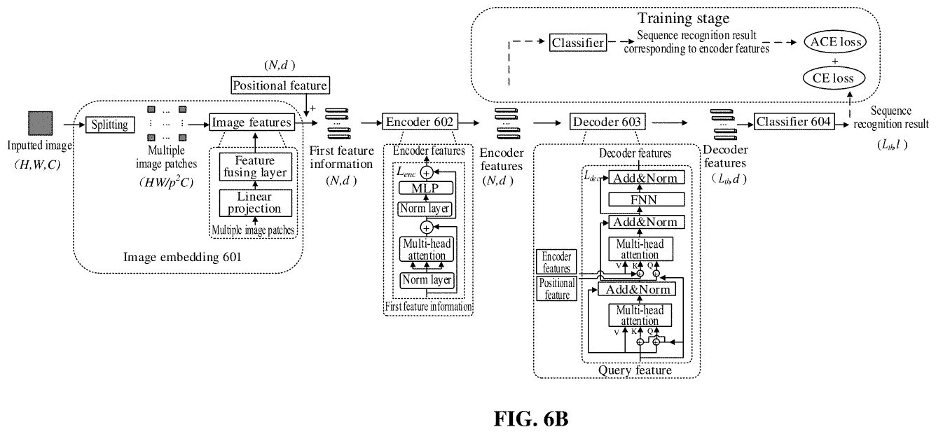

In the embodiments of the disclosure, the to-be-processed image includes the to-be-recognized object sequence, for example, a game token sequence shown in FIG. 6A. It should be noted that the above is only an example, and a type of an object sequence is not limited in the embodiments of the disclosure. The to-be-processed image may be an image acquired by an image acquisition apparatus, or may be a frame image in a video acquired by a video recording apparatus.

In some embodiments, the sequence recognition network may be a Transformer-based deep learning neural network; and the encoder network may be an encoder in a Transformer structure, and the decoder network may be a decoder in the Transformer structure.

In step S102, the to-be-processed image is encoded by using the encoder network to obtain a first feature sequence.

The to-be-processed image may be encoded by using the encoder network, to model relationships between features, thereby obtaining encoder features.

In step S103, the first feature sequence is decoded by using the decoder network to obtain a second feature sequence.

The encoder features may be decoded by using the decoder network, and after being subjected to modeling and feature extraction again, decoder features can be obtained.

In step S104, a sequence recognition result of the object sequence is obtained based on the second feature sequence, where the sequence recognition network is obtained by respectively supervising the encoder network and the decoder network.

The decoder features may be inputted into a classifier to obtain the sequence recognition result of an object sequence, and the classifier may be a linear layer classifier. For example, the to-be-processed image includes a game token sequence that is a stack of game tokens, and the sequence recognition result of the game token sequence may include a category of each game token, a face value of each game token, and a quantity of game tokens in the game token sequence.

In the embodiments of the disclosure, in a training stage, an output of the encoder network and an output of the decoder network may be supervised in a stepwise manner The encoder features are used to recall a category that appears in the sequence by using a first target loss function. The decoder features are used to strongly supervise a category classification result for each position in the sequence by using a second target loss function, to obtain a total loss, and then the sequence recognition network is trained by using the total loss, thereby obtaining a trained sequence recognition network. The trained sequence recognition network is then used to perform sequence recognition on the to-be-processed image, to obtain the sequence recognition result. That is, in the embodiments of the disclosure, the encoder features pass through one linear layer for classification to obtain one output result. The output of the encoder network is also used as an objective of learning to perform supervision. Both outputs are supervised to strengthen the supervision, thereby improving the model effect of the sequence recognition network.

In some embodiments, the encoder network and the decoder network are respectively an encoder network and a decoder network in a Transformer model.

The Transformer model is a Natural Language Processing (NLP) classic model proposed in 2017. The Transformer model uses a Self-Attention mechanism instead of a sequential structure of an RNN, so that models can be trained in parallel, and can have global information. A current Transformer model is widely applied to NLP, and in the field of computer vision, an attention mechanism of a Transformer is also widely applied. A vision Transformer integrates knowledge in the fields of computer vision and NLP, to perform feature extraction on an original image. Extracted features are than inputted into an encoder part of an original Transformer model. Finally, an output of the encoder is then connected to a fully connected layer to classify the image.

In some embodiments, the sequence recognition network is trained in the following manner In step S11, a sample image is acquired. In step S12, the sample image is encoded by using the encoder network to obtain a first sample feature sequence. In step S13, the first sample feature sequence is inputted into a classifier to obtain a first sample sequence recognition result. In step S14, the first sample feature sequence is decoded by using the decoder network to obtain a second sample feature sequence. In step S15, the second sample feature sequence is inputted into the classifier to obtain a second sample sequence recognition result. In step S16, the sequence recognition network is trained based on a target loss function, the first sample sequence recognition result and the second sample sequence recognition result to obtain a trained sequence recognition network.

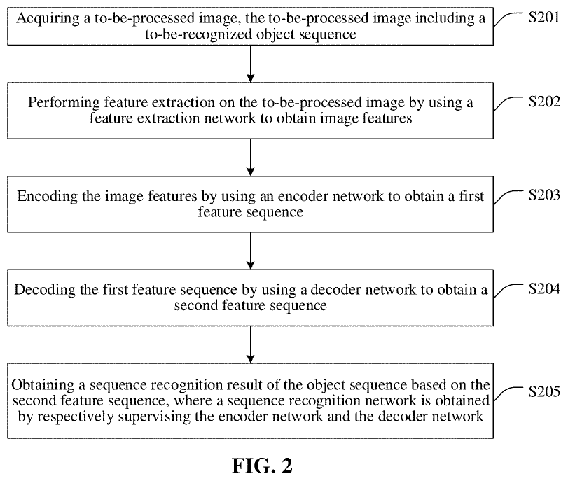

Based on the foregoing embodiments, embodiments of the disclosure further provide a sequence recognition method. The method is applied to an electronic device. FIG. 2 is a second schematic flowchart of implementation of a sequence recognition method according to an embodiment of the disclosure. The method is implemented by using a sequence recognition network. The sequence recognition network at least includes a feature extraction network, an encoder network, and a decoder network. As shown in FIG. 2, the method includes the following steps.

In step S201, a to-be-processed image is acquired, the to-be-processed image including a to-be-recognized object sequence.

In step S202, feature extraction is performed on the to-be-processed image by using the feature extraction network to obtain image features.

Preliminary feature encoding and extraction may be performed on the to-be-processed image by using the feature extraction network.

In step S203, the image features are encoded by using the encoder network to obtain a first feature sequence.

In step S204, the first feature sequence is decoded by using the decoder network to obtain a second feature sequence.

In step S205, a sequence recognition result of the object sequence is obtained based on the second feature sequence, where the sequence recognition network is obtained by respectively supervising the encoder network and the decoder network.

In some embodiments, in a case that the object sequence is a game token sequence, the sequence recognition result of the object sequence at least includes one of: a category of each game token in the game token sequence, a face value of each game token in the game token sequence, and a quantity of game tokens in the game token sequence.

The category of the game token may be a category of a game to which the game token belongs. For example, a recognition result of the game token in the game token sequence is a game token of a Dou dizhu game (card game), and the face value of the game token is 20.

Based on the foregoing embodiments, embodiments of the disclosure further provide a sequence recognition method. The method is applied to an electronic device. The method is implemented by using a sequence recognition network. The sequence recognition network at least includes a feature extraction network, an encoder network, and a decoder network. The method includes the following steps.

In step S211, a to-be-processed image is acquired, the to-be-processed image including a to-be-recognized object sequence.

The function of the feature extraction network is to perform feature extraction on the to-be-processed image, and useful features are kept while useless features are discarded. The functions of the encoder network and the decoder network are to reflect connections between features through modeling to recognize a sequence.

In step S212, the to-be-processed image is segmented to obtain at least two image patches, where no overlap exists between different image patches in the at least two image patches.

In the embodiments of the disclosure, the to-be-processed image may be segmented (that is, split), and the to-be-processed image is segmented into multiple non-overlapping image patches. When no overlap exists between different image patches in the at least two image patches, it means that there is no same part between different image patches. That is, one pixel in the to-be-processed image cannot exist in two image patches.

In step S213, feature extraction is performed on each image patch to obtain an image patch feature corresponding to each image patch.

Each image patch is encoded by using a network with one linear layer, so as to convert each image patch into one feature map. Certainly, another feature extraction method may be used to perform feature extraction on each image patch. This is not limited in the embodiments of the disclosure.

In step S214, image features are obtained based on the image patch features.

The feature extraction network may be used to perform the method in step S212 to step S212. In the embodiments of the disclosure, feature maps of all image patches may be put together to perform subsequent operations. The putting the image patches together may be splicing, or stacking of different channels.

In step S215, the image features are encoded by using the encoder network to obtain a first feature sequence.

In step S216, the first feature sequence is decoded by using the decoder network to obtain a second feature sequence.

In step S217, a sequence recognition result of the object sequence is obtained based on the second feature sequence, where the sequence recognition network is obtained by respectively supervising the encoder network and the decoder network.

In some embodiments, performing feature extraction on each image patch to obtain the image patch feature corresponding to each image patch in step S213 includes: encoding each image patch by using a linear projection operation to obtain the image patch feature corresponding to each image patch.

Based on the foregoing embodiments, embodiments of the disclosure further provide a sequence recognition method. The method is applied to an electronic device. The method is implemented by using a sequence recognition network. The sequence recognition network at least includes a feature extraction network, an encoder network, and a decoder network. The method includes the following steps.

In step S221, a to-be-processed image is acquired, the to-be-processed image including a to-be-recognized object sequence.

In step S222, the to-be-processed image is segmented to obtain at least two image patches, where no overlap exists between different image patches in the at least two image patches.

In step S223, feature extraction is performed on each image patch to obtain an image patch feature corresponding to each image patch.

In step S224, image patch features corresponding to the at least two image patches are combined to obtain a combined feature.

For example, the to-be-processed image is split into 70 image patches. Then feature extraction is performed on each image patch. A size of an obtained image patch feature corresponding to each image patch is (1, d). Image patch features corresponding to all the image patches are combined. A size of an obtained combined feature is (70, d). d is a feature dimension of encoding, and is a hyperparameter of the model.

In step S225, the combined feature is fused in a first dimension to obtain image features.

For example, the to-be-processed image is an image in FIG. 6A. Because a game token sequence is usually reflected in a height dimension of an image, the combined feature may be fused in a width dimension of the image to obtain the image features. The feature extraction network may be used to perform the method in step S222 to step S225.

In step S226, the image features are encoded by using the encoder network to obtain a first feature sequence.

In step S227, the first feature sequence is decoded by using the decoder network to obtain a second feature sequence.

In step S228, a sequence recognition result of the object sequence is obtained based on the second feature sequence, where the sequence recognition network is obtained by respectively supervising the encoder network and the decoder network.

In some embodiments, in step S225, fusing the combined feature in the first dimension to obtain the image features includes: fusing the combined feature in the first dimension by using an average pooling operation to obtain the image features, where the first dimension is a first dimension of the to-be-processed image.

For example, the first dimension may be a height dimension of the to-be-processed image, or may be a width dimension of the to-be-processed image.

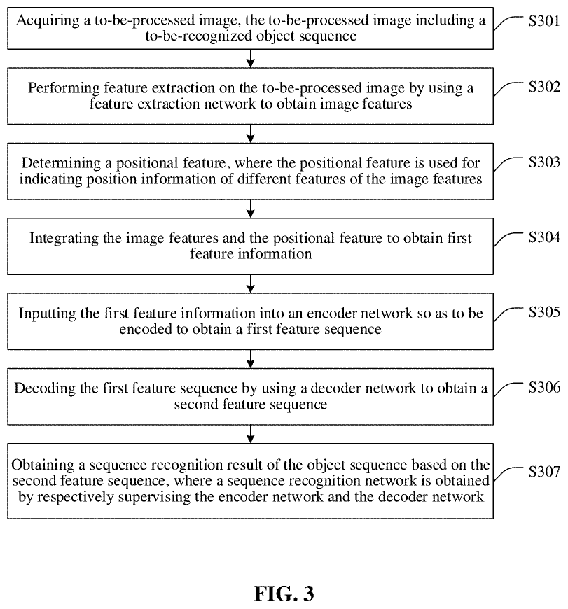

Based on the foregoing embodiments, embodiments of the disclosure further provide a sequence recognition method. The method is applied to an electronic device. FIG. 3 is a third schematic flowchart of implementation of a sequence recognition method according to an embodiment of the disclosure. The method is implemented by using a sequence recognition network. The sequence recognition network at least includes a feature extraction network, an encoder network, and a decoder network. As shown in FIG. 3, the method includes the following steps.

In step S301, a to-be-processed image is acquired, the to-be-processed image including a to-be-recognized object sequence.

In step S302, feature extraction is performed on the to-be-processed image by using the feature extraction network to obtain image features.

In step S303, a positional feature is determined, where the positional feature is used for indicating position information of different features of the image features.

Because a Transformer model does not use the structure of an RNN but instead uses global information and cannot use sequence information of elements, a positional feature is used to store a relative position or an absolute position of a feature in a sequence.

In step S304, the image features and the positional feature are integrated to obtain first feature information.

In the embodiments of the disclosure, a position embedding method in the Transformer model may be used, some coordinate values are used, and a trigonometric function is then used to perform position encoding, so that different encoder information can be obtained for every different position, thereby differentiating embedding of position information of different positions. For example, coordinates of a pixel in an image are encoded to differentiate between different positions, and then the image features are integrated to obtain relationships between features at different positions in an integrated image. Addition may be used to implement fusing between the image features and a positional feature.

In step S305, the first feature information is inputted into the encoder network so as to be encoded to obtain a first feature sequence.

The encoder network includes multiple encoder layers. There are some basic neural network layers in each encoder layer. The arrangement of the multiple encoder layers can implement information exchange between different features and information fusing, so that a fused feature can be eventually obtained.

In step S306, the first feature sequence is decoded by using the decoder network to obtain a second feature sequence.

In step S307, a sequence recognition result of the object sequence is obtained based on the second feature sequence, where the sequence recognition network is obtained by respectively supervising the encoder network and the decoder network.

In some embodiments, the positional feature is obtained through training, and the positional feature and the image feature have a same size.

The positional feature is a learnable parameter, and is initially obtained by using a position with a trigonometric function, and is then gradually optimized through training.

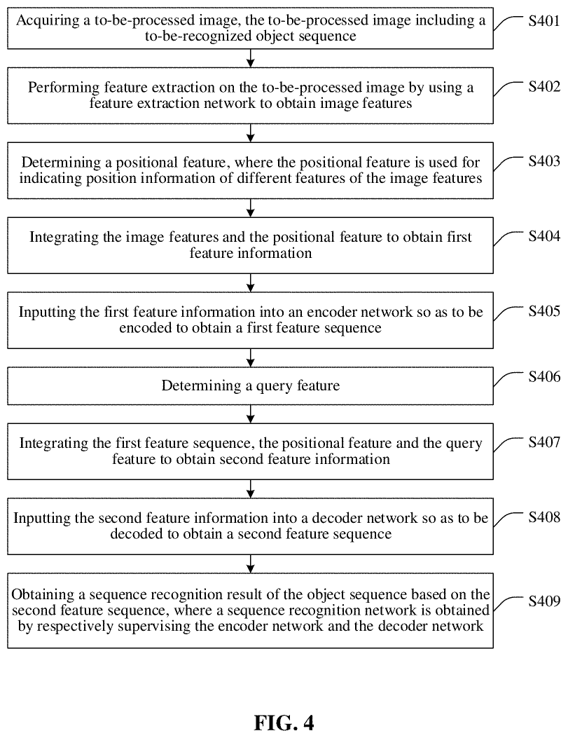

Based on the foregoing embodiments, embodiments of the disclosure further provide a sequence recognition method. The method is applied to an electronic device. FIG. 4 is a fourth schematic flowchart of implementation of a sequence recognition method according to an embodiment of the disclosure. The method is implemented by using a sequence recognition network. The sequence recognition network at least includes a feature extraction network, an encoder network, and a decoder network. As shown in FIG. 4, the method includes the following steps.

In step S401, a to-be-processed image is acquired, the to-be-processed image including a to-be-recognized object sequence.

In step S402, feature extraction is performed on the to-be-processed image by using the feature extraction network to obtain image features.

In step S403, a positional feature is determined, where the positional feature is used for indicating position information of different features of the image features.

In step S404, the image features and the positional feature are integrated to obtain first feature information.

In step S405, the first feature information is inputted into the encoder network so as to be encoded to obtain a first feature sequence.

In step S406, a query feature is determined.

The query feature is also a learnable parameter, and may be randomly initialized, and is then gradually optimized through a network training process. The function of the query feature is to learn a feature on another level other than the image features, and the feature is then fused with the image features to obtain a better recognition result.

In step S407, the first feature sequence, the positional feature and the query feature are integrated to obtain second feature information.

Addition may be used to implement the integration of the first feature sequence, the positional feature and the query feature.

In step S408, the second feature information is inputted into the decoder network so as to be decoded to obtain a second feature sequence.

A size of the second feature sequence is the same as a size of the query feature. The decoder network in this embodiment of the disclosure may include multiple decoder layers. There are some basic neural network layers and a multi-head attention mechanism layer in each decoder layer. Similarly, the arrangement of the multiple decoder layers can implement information exchange between different features and information fusing, so that a fused feature on a deeper level can be eventually obtained.

In step S409, a sequence recognition result of the object sequence is obtained based on the second feature sequence, where the sequence recognition network is obtained by respectively supervising the encoder network and the decoder network.

In some embodiments, the query feature is obtained through training, and a size of the query feature is determined by a feature dimension of the image patch feature and a sequence length of the object sequence.

For example, a size of one image patch feature is (1, d), and a feature dimension of the image patch feature is d. The object sequence is a game token sequence. The game token sequence includes 100 game tokens. A sequence length of the game token sequence is 100.

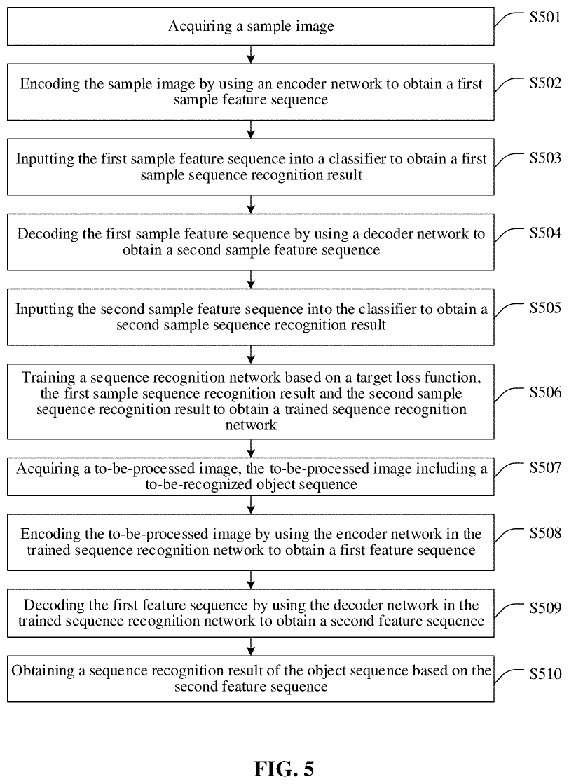

Based on the foregoing embodiments, embodiments of the disclosure further provide a sequence recognition method. The method is applied to an electronic device. FIG. 5 is a fifth schematic flowchart of implementation of a sequence recognition method according to an embodiment of the disclosure. The method is implemented by using a sequence recognition network. The sequence recognition network at least includes an encoder network and a decoder network. As shown in FIG. 5, the method includes the following steps.

In step S501, a sample image is acquired.

In step S502, the sample image is encoded by using the encoder network to obtain a first sample feature sequence.

In step S503, the first sample feature sequence is inputted into a classifier to obtain a first sample sequence recognition result.

In step S504, the first sample feature sequence is decoded by using the decoder network to obtain a second sample feature sequence.

In step S505, the second sample feature sequence is inputted into the classifier to obtain a second sample sequence recognition result.

In step S506, the sequence recognition network is trained based on a target loss function, the first sample sequence recognition result and the second sample sequence recognition result to obtain a trained sequence recognition network.

Step S501 to step S506 are a training process of the sequence recognition network. In the embodiments of the disclosure, the feature outputted by the encoder network is also inputted into the classifier to obtain a classification result. That is, an output of the encoder network is also used as an objective of learning to perform supervision. Both outputs (the output of the encoder network and the output of the decoder network) are supervised to strengthen the supervision.

In step S507, a to-be-processed image is acquired, the to-be-processed image including a to-be-recognized object sequence.

In step S508, the to-be-processed image is encoded by using the encoder network in the trained sequence recognition network to obtain a first feature sequence.

In step S509, the first feature sequence is decoded by using the decoder network in the trained sequence recognition network to obtain a second feature sequence.

In step S510, a sequence recognition result of the object sequence is obtained based on the second feature sequence.

Step S507 to step S510 are included in an inference stage, that is, a stage in which the trained sequence recognition network is used to perform sequence recognition on the to-be-processed image.

Based on the foregoing embodiments, embodiments of the disclosure further provide a sequence recognition method. The method is applied to an electronic device. The method is implemented by using a sequence recognition network. The sequence recognition network at least includes an encoder network and a decoder network. The method includes the following steps.

In step S511, a sample image is acquired.

In step S512, the sample image is encoded by using the encoder network to obtain a first sample feature sequence.

In step S513, the first sample feature sequence is inputted into a classifier to obtain a first sample sequence recognition result.

In step S514, the first sample feature sequence is decoded by using the decoder network to obtain a second sample feature sequence.

In step S515, the second sample feature sequence is inputted into the classifier to obtain a second sample sequence recognition result.

In step S516, a first classification loss is determined based on a first target loss function and the first sample sequence recognition result.

The first target loss function may be an Aggregation Cross-Entropy (ACE) loss function. The ACE loss function is an optimized version of a common Cross-Entropy (CE) loss function. In the embodiments of the disclosure, the first classification loss may be determined by using the ACE loss function, a result of performing sequence recognition on the feature outputted by the encoder network, and label information of the sample image.

In step S517, a second classification loss is determined based on a second target loss function and the second sample sequence recognition result.

The second target loss function may be a common CE loss function. In the embodiments of the disclosure, the second classification loss may be determined by using the common CE loss function, a result of performing sequence recognition on the feature outputted by the decoder network, and label information of the sample image.

It needs to be noted that the types of the first target loss function and the second target loss function are not limited in the embodiments of the disclosure. The type of the first target loss function may be the same as or different from the type of the second target loss function.

In step S518, a total classification loss is determined based on the first classification loss and the second classification loss.

In step S519, parameter optimization is performed on the sequence recognition network by using the total classification loss, thereby obtaining a trained sequence recognition network.

The network parameters of the sequence recognition network may be adjusted by using the total classification loss, to enable a loss outputted by an adjusted sequence recognition network to meet a convergence condition.

In step S520, a to-be-processed image is acquired, the to-be-processed image including a to-be-recognized object sequence.

In step S521, the to-be-processed image is encoded by using the encoder network in the trained sequence recognition network to obtain a first feature sequence.

In step S522, the first feature sequence is decoded by using the decoder network in the trained sequence recognition network to obtain a second feature sequence.

In step S523, a sequence recognition result of the object sequence is obtained based on the second feature sequence.

In some embodiments, determining the total classification loss based on the first classification loss and the second classification loss in step S518 includes the following steps.

In step S5181, weight coefficients respectively corresponding to the first classification loss and the second classification loss are determined, where the weight coefficients are obtained through training.

In step S5182, the total classification loss is determined based on the first classification loss, the second classification loss and the weight coefficients.

Sequence recognition in images is an important research topic in computer vision. Sequence recognition algorithms have a wide range of applications in scenarios such as scene text recognition and license plate recognition. However, for a recognition problem of a game token sequence in a place of entertainment, there is still no related dedicated algorithms for resolving the problem. Theoretically, some sequence recognition algorithms in the prior art may also be applied to the recognition of a game token sequence. However, because a game token sequence usually has a relatively large sequence length and there are relatively high requirements for the prediction accuracy of a face value and a category of each game token, the effect of directly using a conventional sequence recognition method is inadequate.

Based on this, embodiments of the disclosure provide a sequence recognition method for a game token, a Transformer structure-based deep learning neural network is used in the method, to perform end-to-end recognition on an inputted image including a game token sequence, to eventually output a recognition result of the game token sequence in the image, thereby resolving a recognition problem of the game token sequence.

FIG. 6A is a schematic diagram of an image including a game token sequence according to an embodiment of the disclosure. As shown in FIG. 6A, an image 61 includes a game token sequence 62. The game token sequence 62 is a stack of game tokens. The image 61 is a side view of the stack of game tokens. That is, a side of the game token sequence 62 may be seen in the image 61. It needs to be noted that because of the attributes of a game token, a category and a face value of the game token may be determined from a decorative pattern on a side of the game token.

FIG. 6B is a schematic structural diagram of a deep learning neural network according to an embodiment of the disclosure. As shown in FIG. 6B, the Transformer structure-based deep learning neural network mainly includes four parts. The first part is an image embedding 601. The second part is an encoder 602 (that is, a Transformer encoder). The third part is a decoder 603 (that is, a Transformer decoder). The fourth part is a classifier 604. The image embedding 601 is mainly configured to perform preliminary feature encoding and extraction on an inputted image. The encoder 602 is mainly configured to model relationships between features. The decoder 603 is mainly configured to perform modeling and feature extraction again. The classifier 604 is mainly configured to classify a feature outputted by the decoder to obtain a final sequence recognition result.

The foregoing four parts are described below in detail:

1) Image embedding 601

This part is mainly configured to perform preliminary feature encoding and extraction on an inputted image (for example, the image in FIG. 6A). A size of the image is (H, W, C), H is a height of the inputted image, W is a width of the inputted image, and C is a quantity of channels of the inputted image. Similar to a common Transformer structure of vision, the inputted image is first split into M image patches that do not overlap, and a quantity M of the image patches may be obtained by using the following Formula (1):

$$M = \frac{HW}{{p}^{2}} , \qquad ( 1 )$$

where p is a size of each image patch, H and W are respectively a height and a width of the inputted image.

The image patch is then encoded through linear mapping (that is, Linear Projection) to obtain a feature map, the size of the feature map is (M, d), where d is a feature dimension of encoding, and is a hyperparameter of the model. In this embodiment of the disclosure, because a game token sequence is usually reflected in a height dimension of an image (as shown in FIG. 6A), after linear mapping, one feature fusing layer (that is, a Merge&Flatten layer) is added in the embodiments of the disclosure. Features are fused in a width dimension of the image through average pooling, to obtain final image features (that is, image embeddings). The size of the image feature is (N, d), and N may be obtained by using the following Formula (2):

$$N = \frac{H}{p} , \qquad ( 2 )$$

where H is a height of the inputted image, and p is the size of the image patch.

2) Encoder 602

The obtained image features and a positional feature (that is, positional embedding) encoded with image position information are integrated, to obtain first feature information as an input of the encoder 602. A relationship between features is modeled by using the encoder 602, to obtain encoder features. The structure shown in FIG. 6B is a basic structure of an encoder layer. The encoder 602 may be formed by stacking L_{enc} encoder layers. L_{enc} is a quantity of the encoder layers in the encoder 602, and is a hyperparameter of the model.

An output of an encoder layer is an input of a next encoder layer in the encoder 602, an input of the first encoder layer is the first feature information, and an output of the last encoder layer is the encoder features. Each encoder layer includes a normalization (Norm) layer, a multi-head attention mechanism layer, and a Multilayer Perceptron (MLP). The multi-head attention mechanism layer is formed by multiple self-attention mechanisms. The symbol e denotes element-wise addition.

3) Decoder 603

The obtained encoder features, the positional feature and an initialized query feature (that is, query embedding) are used as inputs. The decoder 603 performs modeling and feature extraction again to obtain decoder features. The structure shown in FIG. 6B is a basic structure of a decoder layer. The decoder 603 may be formed by stacking L_{dec} decoder layers. L_{dec} is a quantity of the decoder layers in the decoder 603, and is a hyperparameter of the model. A size of the query feature is (Lₜₕ, 1), where d is a feature dimension of encoding of the feature map, and Lₜₕ is a predefined value, and is related to a sequence length of the game token sequence in the inputted image. For example, the length of the game token sequence in each inputted image is not greater than 100, Lₜₕ may be set to 100. A size of the decoder feature is the same as the size of the query feature. That is, the size of the decoder feature is (Lₜₕ, 1).

An output of a decoder layer is an input of a next decoder layer in the decoder 603. Inputs of the first decoder layer are the encoder features, the positional feature and the query feature. An output of the last decoder layer is the decoder features. Each decoder layer includes the multi-head attention mechanism layer, an Add&Norm layer, and a Feedforward Neural Network (FFN). The multi-head attention mechanism layer is formed by multiple self-attention mechanisms. The Add&Norm layer is formed by an Add part and a Norm part. Add denotes a residual connection used for preventing network degradation, and Norm is used for normalizing a feature. the symbol ⊕ denotes element-wise addition. Inputs of the multi-head attention mechanism layer include a matrix V (value), a matrix K (key value), and a matrix Q (query). The matrix V, the matrix K, and the matrix Q are obtained by performing linear transform on the inputs.

4) Classifier 604

A linear classifier may be used. Category classification prediction is performed on both the encoder features and the decoder features in the training stage. Category classification prediction is performed on the decoder features in the inference stage, where prediction results include n+1 categories, n is a total quantity of categories of game tokens, and an (n+1)^{th} category is a non-game token (that is, a terminator category), to obtain a final sequence recognition result. A size of the sequence recognition result is (Lₜₕ, 1).

In the training stage, an output of the encoder 602 and an output of the decoder 603 may be supervised in a stepwise manner. That is, the output of the encoder 602 is used to recall a category that appears in the sequence by using an ACE loss. The output of the decoder 603 is used to strongly supervise a category classification result at each position in the sequence by using a CE loss. The neural network is then trained by using the total loss. The total loss may be obtained by using the following Formula (3):

Lₗₒₛₛ=αL_{ace}+βL_{ce} (3),

where L_{ace} is a classification loss obtained by supervising the output of the encoder 602, L_{ce} is a classification loss obtained by supervising the output of the decoder 603, α and β are respectively weights corresponding to the foregoing two losses, α and β are hyperparameters in a training process.

Certainly, in an inference stage, the obtained classification result further needs to be post-processed (that is, the prediction of the (n+1)^{th} category is removed) to obtain the sequence recognition result of the game token.

In the embodiments of the disclosure, a solution of implementing a recognition task of a game token sequence by using a Transformer structure is proposed. A conventional Transformer structure is adjusted in the solution. A new image embedding method is proposed. A decoder structure is added, and outputs of an encoder and a decoder are separately supervised in a stepwise manner, so that a series of problems such as the current situation that there is no deep learning-based sequence recognition of a game token in the prior art and the failure to adequately satisfy a recognition task of a game token by using a common sequence recognition method can be resolved. In this way, a sequence recognition task can be simplified, end-to-end training is implemented by using the Transformer structure, and a procedure is simple. The strong modeling and encoding capability of a Transformer is used, so that an adequate recognition effect of a game token can be achieved. That is, game tokens can be counted and recognized by using this solution in a place of entertainment, so that it is easier and faster to perform a redemption procedure and count the number of game tokens, thereby saving manpower.

Based on the foregoing embodiments, embodiments of the disclosure provide a sequence recognition apparatus. The units included in the apparatus, the subunits and the modules included in the units, and the sub-modules and portions included in the modules may be implemented by a processor in the apparatus, or certainly may be implemented by a specific logical circuit. During implementation, the processor may be a Central Processing Unit (CPU), a Microprocessor Unit (MPU), a Digital Signal Processor (DSP) or a Field Programmable Gate Array (FPGA), or the like.

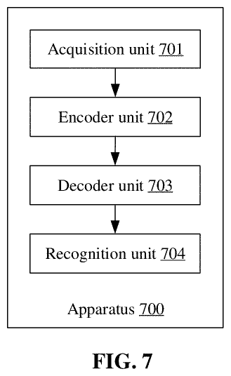

FIG. 7 is a schematic structural diagram of a sequence recognition apparatus according to an embodiment of the disclosure. The apparatus is implemented by using a sequence recognition network. The sequence recognition network at least includes an encoder network and a decoder network. As shown in FIG. 7, the apparatus 700 includes:

an acquisition unit 701, configured to acquire a to-be-processed image, the to-be-processed image including a to-be-recognized object sequence;

an encoder unit 702, configured to encode the to-be-processed image by using the encoder network to obtain a first feature sequence;

a decoder unit 703, configured to decode the first feature sequence by using the decoder network to obtain a second feature sequence; and

a recognition unit 704, configured to obtain a sequence recognition result of the object sequence based on the second feature sequence, where the sequence recognition network is obtained by respectively supervising the encoder network and the decoder network.

In some embodiments, the sequence recognition network further includes a feature extraction network; and the encoder unit 702 includes:

a feature extraction module, configured to perform feature extraction on the to-be-processed image by using the feature extraction network to obtain image features; and

an encoder module, configured to encode the image features by using the encoder network to obtain the first feature sequence.

In some embodiments, the feature extraction module includes:

a splitting module, configured to segment the to-be-processed image to obtain at least two image patches, where no overlap exists between different image patches in the at least two image patches; and

a feature extraction sub-module, configured to perform feature extraction on each image patch to obtain an image patch feature corresponding to each image patch, where

the feature extraction sub-module is further configured to obtain the image features based on the image patch features.

In some embodiments, the feature extraction sub-module includes:

a combination portion, configured to combine image patch features corresponding to the at least two image patches to obtain a combined feature; and

a fusing portion, configured to fuse the combined feature in a first dimension to obtain the image features.

In some embodiments, the fusing portion includes:

a fusing sub-portion, configured to fuse the combined feature in the first dimension by using an average pooling operation to obtain the image features, where the first dimension is a first dimension of the to-be-processed image.

In some embodiments, the feature extraction sub-module includes:

a feature extraction sub-portion, configured to encode each image patch by using a linear projection operation to obtain the image patch feature corresponding to each image patch.

In some embodiments, the encoder module includes:

a positional feature determination portion, configured to determine a positional feature, where the positional feature is used for indicating position information of different features of the image features;

an integration portion, configured to integrate the image features and the positional feature to obtain first feature information; and

an encoder portion, configured to input the first feature information into the encoder network so as to be encoded to obtain the first feature sequence.

In some embodiments, the positional feature is obtained through training, and the positional feature and the image feature have a same size.

In some embodiments, the decoder unit 703 includes:

a query feature determination module, configured to determine a query feature;

an integration module, configured to integrate the first feature sequence, the positional feature and the query feature to obtain second feature information; and

a decoder module, configured to input the second feature information into the decoder network so as to be decoded to obtain the second feature sequence.

In some embodiments, the query feature is obtained through training, and a size of the query feature is determined by a feature dimension of the image patch feature and a sequence length of the object sequence.

In some embodiments, the encoder network and the decoder network are respectively an encoder network and a decoder network in a Transformer model.

In some embodiments, in a case that the object sequence is a game token sequence, the sequence recognition result of the object sequence at least includes one of:

a category of each game token in the game token sequence, a face value of each game token in the game token sequence, and a quantity of game tokens in the game token sequence.

In some embodiments, the apparatus further includes a training unit, configured to train the sequence recognition network.

In some embodiments, the training unit includes:

a sample acquisition module, configured to acquire a sample image;

a sample encoder module, configured to encode the sample image by using the encoder network to obtain a first sample feature sequence;

a first classification module, configured to input the first sample feature sequence into a classifier to obtain a first sample sequence recognition result;

a sample decoder module, configured to decode the first sample feature sequence by using the decoder network to obtain a second sample feature sequence;

a second classification module, configured to input the second sample feature sequence into the classifier to obtain a second sample sequence recognition result; and

a training module, configured to train the sequence recognition network based on a target loss function, the first sample sequence recognition result and the second sample sequence recognition result to obtain a trained sequence recognition network.

In some embodiments, the target loss function includes a first target loss function and a second target loss function; and the training module includes:

a first loss determination portion, configured to determine a first classification loss based on the first target loss function and the first sample sequence recognition result;

a second loss determination portion, configured to determine a second classification loss based on the second target loss function and the second sample sequence recognition result;

a total loss determination portion, configured to determine a total classification loss based on the first classification loss and the second classification loss; and

an optimization portion, configured to perform parameter optimization on the sequence recognition network by using the total classification loss.

In some embodiments, the total loss determination portion includes:

a total loss determination sub-portion, configured to determine weight coefficients respectively corresponding to the first classification loss and the second classification loss, where the weight coefficients are obtained through training,

where the total loss determination sub-portion is further configured to determine the total classification loss based on the first classification loss, the second classification loss and the weight coefficients.

The above description of the apparatus embodiments is similar to the description of the method embodiments above, and has beneficial effects similar to those of the method embodiments. For technical details not disclosed in the apparatus embodiments of the disclosure, refer to the description of the method embodiments of the disclosure for comprehension.

It needs to be noted that in the embodiments of the disclosure, when the foregoing sequence recognition method is implemented in the form of a software functional unit and sold or used as an independent product, the method may be stored in a computer-readable storage medium. Based on such an understanding, the technical solutions in the embodiments of the disclosure essentially, or the part contributing to the prior art may be implemented in the form of a software product. The software product is stored in one storage medium and includes several instructions for instructing an electronic device (which may be a personal computer, a server or the like) to perform all or some of the steps of the method described in the embodiments of the disclosure. The foregoing storage medium includes various media that can store program code, such as a Universal Serial Bus (USB) flash drive, a removable hard disk, a Read-Only Memory (ROM), a magnetic disk or an optical disc. In this way, the embodiments of the disclosure are not limited to any specific combination of hardware and software.

Correspondingly, embodiments of the disclosure provide an electronic device, including a memory and a processor, the memory storing a computer program executable on the processor, the processor executing the program to implement the steps in the sequence recognition method provided in the foregoing embodiments.

Correspondingly, embodiments of the disclosure provide a readable storage medium, storing a computer program, where a processor is configured to execute the computer program to implement the steps in the foregoing sequence recognition method.

It needs to be noted that the above description of the embodiments of the storage medium and platform is similar to the description of the method embodiments above, and has beneficial effects similar to those of the method embodiments. For technical details not disclosed in the embodiments of the storage medium and platform of the disclosure, refer to the description of the method embodiments of the disclosure for comprehension.

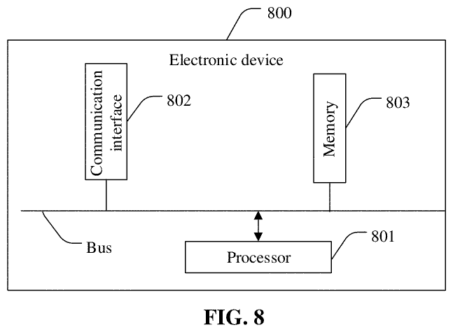

It needs to be noted that FIG. 8 is a schematic diagram of a hardware entity of an electronic device according to an embodiment of the disclosure. As shown in FIG. 8, a hardware entity of an electronic device 800 includes a processor 801, a communication interface 802, and a memory 803.

The processor 801 usually controls the overall operations of the electronic device 800.

The communication interface 802 may enable the electronic device 800 to communicate with another platform or electronic device or server through a network.

The memory 803 is configured to store instructions and applications executable by the processor 801, and may also cache data (for example, image data, audio data, voice communication data, and video communication data) to be processed or already processed by the processor 801 and the modules in the electronic device 800, either through a flash memory or a Random Access Memory (RAM).

In several embodiments provided in the disclosure, it should be understood that the disclosed device and method may be implemented in other forms. The described device embodiments are merely an example. For example, the unit division is merely logical function division and may be other division in actual implementation. For example, multiple units or components may be combined or integrated into another system, or some features may be ignored or not performed. In addition, the shown or discussed mutual couplings or direct couplings or communication connections between the components may be implemented through some interfaces, indirect couplings or communication connections between the apparatuses or units, or electrical connections, mechanical connections, or connections in other forms.

The units described as separate parts may or may not be physically separate, and parts shown as units may or may not be physical units, that is, may be located in one position, or may be distributed on multiple network units. Some or all of the units may be selected according to actual needs to achieve the objects of the solutions in the embodiments.

In addition, functional units in the embodiments of the disclosure may all be integrated into one processing module, or each of the units may exist alone, or two or more units are integrated into one unit. The integrated unit may be implemented in the form of hardware or a software functional unit in addition to hardware. A person of ordinary skill in the art may understand that all or some of the steps in implementing the foregoing method embodiments may be accomplished by a program instructing relevant hardware. The foregoing program may be stored in a computer-readable storage medium. The problem, when executed, performs the steps in the foregoing method embodiments. The foregoing storage medium includes various media that can store program code such as a removable storage device, a ROM, a RAM, a magnetic disk or an optical disc.

The methods disclosed in several method embodiments provided in the disclosure may be arbitrarily combined with each other without causing any conflict to obtain new method embodiments.

The features disclosed in several product embodiments provided in the disclosure may be arbitrarily combined with each other without causing any conflict to obtain new product embodiments.

The features disclosed in several method or device embodiments provided in the disclosure may be arbitrarily combined with each other without causing any conflict to obtain new method embodiments or device embodiments.

The foregoing descriptions are merely specific implementations of the disclosure, but are not intended to limit the protection scope of the disclosure. Any variation or replacement that may be readily figured out by a person skilled in the art within the technical scope disclosed in the disclosure shall fall within the protection scope of the disclosure. Therefore, the protection scope of the disclosure shall be subject to the protection scope of the claims.

1. A sequence recognition method, implemented by using a sequence recognition network comprising at least an encoder network and a decoder network, the method comprising:
acquiring a to-be-processed image, the to-be-processed image comprising a to-be-recognized object sequence;
encoding the to-be-processed image by using the encoder network to obtain a first feature sequence;
decoding the first feature sequence by using the decoder network to obtain a second feature sequence; and
obtaining a sequence recognition result of the object sequence based on the second feature sequence, wherein the sequence recognition network is obtained by respectively supervising the encoder network and the decoder network.

2. The method of claim 1, wherein the sequence recognition network further comprises a feature extraction network; and
encoding the to-be-processed image by using the encoder network to obtain the first feature sequence comprises:
performing feature extraction on the to-be-processed image by using the feature extraction network to obtain image features; and
encoding the image features by using the encoder network to obtain the first feature sequence.

3. The method of claim 2, wherein performing feature extraction on the to-be-processed image by using the feature extraction network to obtain the image features comprises:
segmenting the to-be-processed image to obtain at least two image patches, wherein no overlap exists between different image patches in the at least two image patches;
performing feature extraction on each image patch to obtain an image patch feature corresponding to each image patch; and
obtaining the image features based on the image patch features.

4. The method of claim 3, wherein obtaining the image features based on the image patch features comprises:
combining image patch features corresponding to the at least two image patches to obtain a combined feature; and
fusing the combined feature in a first dimension to obtain the image features.

5. The method of claim 4, wherein fusing the combined feature in the first dimension to obtain the image features comprises:
fusing the combined feature in the first dimension by using an average pooling operation to obtain the image features, wherein the first dimension is a first dimension of the to-be-processed image.

6. The method of claim 3, wherein performing feature extraction on each image patch to obtain the image patch feature corresponding to each image patch comprises:
encoding each image patch by using a linear projection operation to obtain the image patch feature corresponding to each image patch.

7. The method of claim 2, wherein encoding the image features by using the encoder network to obtain the first feature sequence comprises:
determining a positional feature, wherein the positional feature is used for indicating position information of different features of the image features;
integrating the image features and the positional feature to obtain first feature information; and
inputting the first feature information into the encoder network so as to be encoded to obtain the first feature sequence.

8. The method of claim 7, wherein the positional feature is obtained through training, and the positional feature and the image feature have a same size.

9. The method of claim 7, wherein decoding the first feature sequence by using the decoder network to obtain the second feature sequence comprises:
determining a query feature;
integrating the first feature sequence, the positional feature and the query feature to obtain second feature information; and
inputting the second feature information into the decoder network so as to be decoded to obtain the second feature sequence.

10. The method of claim 9, wherein the query feature is obtained through training, and a size of the query feature is determined by a feature dimension of an image patch feature and a sequence length of the object sequence.

11. The method of claim 1, wherein the encoder network and the decoder network are respectively an encoder network and a decoder network in a Transformer model.

12. The method of claim 1, wherein in a case that the object sequence is a game token sequence, the sequence recognition result of the object sequence at least comprises one of:
a category of each game token in the game token sequence, a face value of each game token in the game token sequence, and a quantity of game tokens in the game token sequence.

13. The method of claim 1, wherein the sequence recognition network is trained by:
acquiring a sample image;
encoding the sample image by using the encoder network to obtain a first sample feature sequence;
inputting the first sample feature sequence into a classifier to obtain a first sample sequence recognition result;
decoding the first sample feature sequence by using the decoder network to obtain a second sample feature sequence;
inputting the second sample feature sequence into the classifier to obtain a second sample sequence recognition result; and
training the sequence recognition network based on a target loss function, the first sample sequence recognition result and the second sample sequence recognition result to obtain a trained sequence recognition network.

14. The method of claim 13, wherein the target loss function comprises a first target loss function and a second target loss function; and training the sequence recognition network based on the target loss function, the first sample sequence recognition result and the second sample sequence recognition result comprises:
determining a first classification loss based on the first target loss function and the first sample sequence recognition result;
determining a second classification loss based on the second target loss function and the second sample sequence recognition result;
determining a total classification loss based on the first classification loss and the second classification loss; and
performing parameter optimization on the sequence recognition network by using the total classification loss.

15. The method of claim 14, wherein determining the total classification loss based on the first classification loss and the second classification loss comprises:
determining weight coefficients respectively corresponding to the first classification loss and the second classification loss, wherein the weight coefficients are obtained through training; and
determining the total classification loss based on the first classification loss, the second classification loss and the weight coefficients.

16. A sequence recognition apparatus, implemented by using a sequence recognition network comprising at least an encoder network and a decoder network, the apparatus comprising:
a memory storing processor-executable instructions; and
a processor configured to execute the processor-executable instructions to perform operations of:
acquiring a to-be-processed image, the to-be-processed image comprising a to-be-recognized object sequence;
encoding the to-be-processed image by using the encoder network to obtain a first feature sequence;
decoding the first feature sequence by using the decoder network to obtain a second feature sequence; and
obtaining a sequence recognition result of the object sequence based on the second feature sequence, wherein the sequence recognition network is obtained by respectively supervising the encoder network and the decoder network.

17. The apparatus of claim 16, wherein the sequence recognition network further comprises a feature extraction network; and
encoding the to-be-processed image by using the encoder network to obtain the first feature sequence comprises:
performing feature extraction on the to-be-processed image by using the feature extraction network to obtain image features; and
encoding the image features by using the encoder network to obtain the first feature sequence.

18. The apparatus of claim 17, wherein performing feature extraction on the to-be-processed image by using the feature extraction network to obtain the image features comprises:
segmenting the to-be-processed image to obtain at least two image patches, wherein no overlap exists between different image patches in the at least two image patches;
performing feature extraction on each image patch to obtain an image patch feature corresponding to each image patch; and
obtaining the image features based on the image patch features.

19. The apparatus of claim 18, wherein obtaining the image features based on the image patch features comprises:
combining image patch features corresponding to the at least two image patches to obtain a combined feature; and
fusing the combined feature in a first dimension to obtain the image features.

20. A non-transitory computer-readable storage medium having stored thereon computer-executable instructions that, when executed by a processor, cause the processor to perform operations of:
acquiring a to-be-processed image, the to-be-processed image comprising a to-be-recognized object sequence;
encoding the to-be-processed image by using an encoder network to obtain a first feature sequence;
decoding the first feature sequence by using an decoder network to obtain a second feature sequence; and
obtaining a sequence recognition result of the object sequence based on the second feature sequence, wherein a sequence recognition network is obtained by respectively supervising the encoder network and the decoder network.
